(19) United States
(12) Patent Application Publication
(10) Pub. No.: US 2007/0261864 A1
(43) Pub. Date: Nov. 15, 2007

(54) Composite multi-layer polymeric horseshoes for shock attenuation

(76) Inventor: C. J. Gonslaves, Glendora, CA (US)

Correspondence Address: DONALD D. MON;ATTORNEY AT LAW, SUITE 303, 750 EAST GREEN STREET, PASADENA, CA, 91101, US

(21) Appl. No.: 11/433,763

(22) Filed: May 11, 2006

(51) Int. Cl. A01L 7/02

(52) U.S. Cl. 168/12

(57) ABSTRACT

A composite multi-layer horseshoe. The horseshoe has a shoe for wear and shock attenuation. A pad on the shoe bears against the hoof. It also attenuates the shock of impact on the ground. The shoe and pad are made from different polymers with different attenuation properties.

### FIELD OF THE INVENTION

Horseshoes which damp the strong impact forces on a horse's hoof when it strikes the ground during high performance exercise such as in racing or jumping.

### BACKGROUND OF THE INVENTION

A horse's hoof is a very sensitive part of the animal. It is much too sensitive for it to be directly impacted on the ground during high performance exertions such as are commonly encountered in racing and jumping. For this reason, and to lessen the wear on the hoof, a horseshoe is routinely applied.

The classical horseshoe is a U-shaped metal body which the farrier selects for size, bends it to fit, and nails it to the hoof. The metal shoe has two necessary features. First, it has a good wearing surface, and second, it can be bent to shape. It takes the abrasive wear and protects the hoof from sharp objects and surface irregularities which could cause locally amplified impact forces.

For work horses which plod along, whose hoofs impact the ground relatively gently, or which work in a soft field, this invention, and even a standard metal horseshoe, offers only limited advantage, which often would not be necessary at all. However, the hoof of a performance horse endures entirely different forces. Surprisingly, each foot of a race horse running at a speed on the order of about 35 miles per hour, strikes the ground about every 0.1 second. The average horse weighs on the order of about 1,200 pounds. Each hoof strikes the ground with a strong force exerted directly through the shoe. The shoe, of course takes the wear, but it also transmits the energy of the blow. The blow is a quick one, and it generates a sharp spike of energy which it delivers directly to the hoof as a shock. Still this is better than the same force exerted on the bare hoof.

Because the shoe is metal, and because the horseshoe is U-shaped, it will ring with a frequency and energy that the sensitive hoof will feel. With such a short period of time between blows, the result is an almost continuous ringing, accompanied by a very quick succession of sharp spikes of energy on the hoof, to the great discomfort of the animal. For a performance horse this is a built-in distraction that the animal endures, but at the cost of at least some impairment of function related to inherent response.

Even worse, but necessarily, the horseshoe is coupled to the hoof by nails driven through it into the hoof. These nails, in turn, have to be in intimate shock-conducting contact with the metal shoe, and are embedded in the hoof. Their vibration tends to loosen the nails, and the shoe may be lost. Also the nails act to transmit some of the vibrating forces, directly to the hoof.

The consequence of all of this is that the active horse is subjected to a steady burst of energy consisting of spikes of energy and a nearly continuous ringing sensation applied to a very sensitive part.

A previous effort has been made (with substantial success), to mitigate this situation. In applicant's U.S. Pat. No. 6,378,615, issued Apr. 30, 2002, there is disclosed the use of a shock-attenuating pad placed between a metal shoe and the hoof, the shoe being nailed to the hoof. This horseshoe, known by the trademark NO-VIBE, has enjoyed considerable success, especially on high-value, high performance horses. In recent Kentucky Derby races, it has been common for at least three of the first four finishers to wear these horseshoes. Of course many other horses do too. Their use is enjoyed not only by other high value horses in racing or other performance competition, but also on other horses of lesser but still substantial economic value, and those of sentimental value. In these, the additional cost of an advanced horseshoe is acceptable. Observation of horses equipped with these horseshoes has shown improved performance reflective of more comfortable hoofs.

The NO-VIBE prior art horseshoes are expected to remain popular even after the horseshoes of this invention become more available. Good horseshoes are expensive, and so is the fee for the farrier to apply them. For horses of lesser grade and value, it is reasonable economy to provide horseshoes that wear longer, such as a plain metal shoe without a pad. However, a composite 6 horseshoe such as the NO-VIBE (metal shoe and pad), while costing more, can justify keeping a less-performing horse in action for a longer time while its part of the purse will justify its cost. It should be noted that parts of the purse are usually paid at least to the fifth horse. Of course the winner collects much more than the later horses, but the lower payoffs for later finishers can justify keeping the horse at the track. This is enough to keep many horses in action, without which there would be no races.

It is an object of this invention to provide a shock-attenuating horseshoe with properties superior to those of already-known horseshoes.

### BRIEF DESCRIPTION OF THE INVENTION

A horseshoe according to this invention has the plan view of a classical horseshoe. It has a central bight, placed forwardly on the hoof, and an arm extending away from each end of the bight to a respective tip. The tips are spaced apart so the arms extend along the sole of the hoof near its edges. In some situations, a bar interconnects the tips.

The shoe has a bottom wear surface and a usually flat upper surface. A groove can be provided in the wear surface along the bight and along the arms to the tips. The groove receives the heads of nails which are driven through the shoe. The shoe may have holes to pass the shanks of the nails.

A polymeric pad has a plan view similar to that of the shoe, with a lower surface and a flat upper surface (both usually flat). The pad is to bear against the sole of the hoof. The upper surface of the shoe and the lower surface of the pad are intimately joined by fusion or with cement.

According to this invention, the shoe is made of a polymeric material that is resistant to wear and which has the inherent property of molecular uncurling and curling when stretched and relaxed so as to damp the energy of periodic blows.

Similarly, the pad is polymeric with similar inherent properties, but made of a different polymer, so as to provide a secondary and supplementary damping action responsive to energy transmitted to it by the shoe. However, the damping properties of the material of the shoe and of the pad are different and supplementary.

The sequential dampings (which occur nearly simultaneously) profoundly reduce the magnitude of the shock of the blow delivered to the hoof itself. While the energy of the blow must of course be absorbed or transmitted, the maximum amplitude (spike) of the shock wave when it reaches the hoof is reduced to a level believed not to be troubling to the animal.

As a consequence of this construction there is an in-series reduction of peak loads and energy transfer to the hoof. The same load is applied to the hoof, but its force are attenuated by two damping components. First, the energy transmitted is greatly reduced by the non-metallic shoe instead of merely being totally transmitted by a metal shoe. As a consequence, peak loads are initially reduced, and much of the energy of the blow which otherwise would be transmitted by vibration, is dissipated in the shoe itself. Second, the pad between the shoe and the hoof further damps the energy wave. The attenuating properties of the shoe and of the pad are dissimilar and complementary

According to a preferred feature of the invention, the shoe is made of Nylon, particularly Nylon 6 reinforced with glass fiber, The material of the pad is preferably made of polyvinyl chloride resin.

The dimensions of the shoe closely resemble those of a common metal shoe. It total thickness is generally about 2 inch. Because the shoe cannot be reshaped by the farrier, it will usually be made available in half and full sizes.

The above and other features of this invention will be fully understood from the following detailed description and the accompanying drawings, in which:

### BRIEF DESCRIPTION OF THE DRAWINGS

FIG. 1 is a plan view of the bottom of a horseshoe according to this invention;

FIG. 2 is a plan view of the top of the horseshoe of FIG. 1;

FIG. 3 is a right hand view of FIG. 1; and

FIG. 4 is a cross-section taken at line 4-4 in FIG. 1.

### DETAILED DESCRIPTION OF THE INVENTION

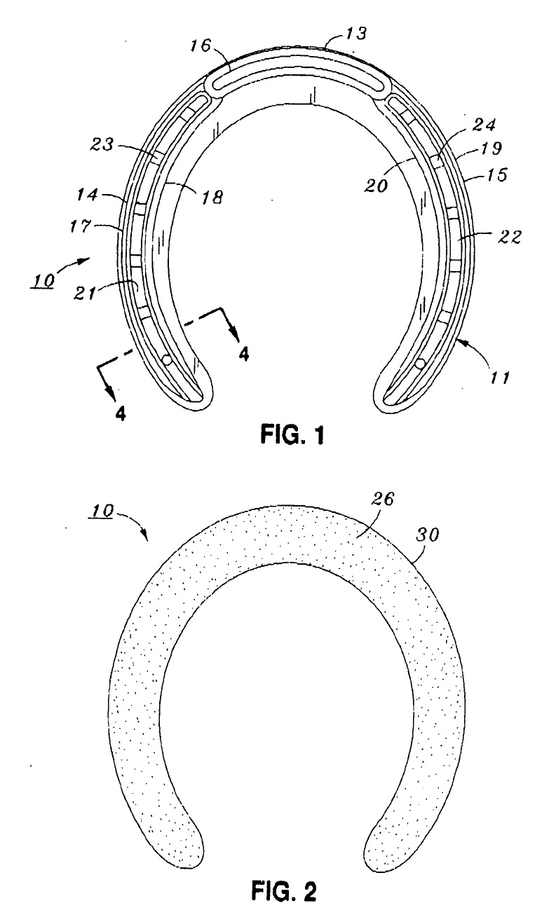

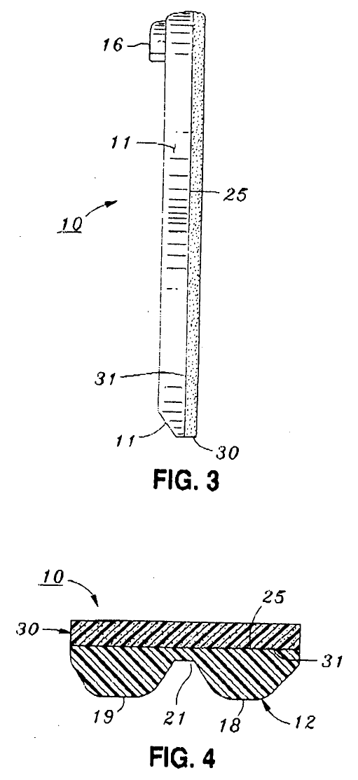

A composite horseshoe 10 according to this invention is shown in FIG. 1. It includes a shoe 11 with a lower wear surface 12. It is generally U-shaped, having a bight section 13 and two arms 14, 15. An optional cleat 16 can be attached to the bight. Ridges 17, 18, 19 and 20 extend along the arms to form grooves 21, 22. A series of nail holes 23, 24 can be formed at the bottom of the groove. If these holes are not provided, the nails may instead be driven through the plastic material. The shoe has a flat upper interface surface 25 (FIG. 4).

It is to be understood that features such as the ridges, grooves and cleat are optional. They may be omitted, and other shapes useful for horseshoes such as clogs may be used also or instead.

A flexible pad 30 has a lower interface surface 31 laid on and fixed to upper interface surface 25 of the metal shoe by fusion or cement. Although these surfaces can be configured or grooved, it is best practice for them to be flat. They are coextensive. The pad dimensions are substantially the same as those of surface 25. Their outer peripheries are substantially congruent. A bearing surface 26, preferably flat is on the top of the pad. It bears against the hoof when the horseshoe is attached.

The pad is made of an organic plastic polymeric substance which is resilient enough to withstand the pounding given to it between the hoof and the shoe, and flexible enough to attenuate most of the vibration energy. It is best practice to mold this pad in a single piece. A suitable material of construction is a flexible highly plasticized polyvinyl chloride, with shore hardness about 75. A thickness of about ⅛ inches will ordinarily be sufficient. A much larger thickness will add unnecessary thickness which is a disadvantage for a competitive horse.

The shoe is also made of polymer which provides good resistance to surface abrasion and good properties of energy attenuation under compressive loads. Extensive efforts have been made by the inventor herein to find the most useful and appropriate materials for the shoe and the pad. Clearly their function is to be complimentary to the other. Should their properties be alike, it would be as well to make the entire horse shoe of the same material. Such is clearly not the case.

Experimentation has shown that optimum properties for the shoe are provided by polyamide material, principally NYLON 6, provided with glass fiber reinforcement. An especially useful formulation is obtainable from TORAY RESIN COMPANY under its mark AMILAN CM 1011G-30. Other Nylon formulations are also useful but this one has proved to be very effective in its response to abrupt impact loads and to surface wear.

Experimentation with materials for the pads have shown the advantage of linear polymers, especially polyvinyl chloride. A useful molecular weight (MW) is around 17. It will be suitably plasticized so as to form a pad with its own energy absorption and transmission properties. It should be sufficiently flexible at anticipated temperatures and strong enough to withstand the periodical blow. Importantly, its damping response to a given shock must be different from that of the material of the shoe.

It is inherent in the nature of the polyamides and the polyvinyls that their responses are different, so that the energy spike delivered to the pad is not only different from that of the shoe, but is time phased from it, so that the action of the pad is complementary to the energy blow which survived the shoe and is delivered to the pad.

Thus, this invention contemplates the use of two joined plastic bodies, one of which receives the blows and the other which delivers the attenuated blow to the hoof, each of which attenuates the blow, but in a combination of different attenuates.

It will especially be noticed that the shoe, because it is made of a polymer, will not “ring” as a metal shoe would do. Thus this feature limits and reduces this energy component.

The pad is preferably not pierced for the nails. Instead when the nails are driven through it they are gripped and retained by the pad, and in turn their energy is attenuated by the pad.

This invention is not to be limited by the embodiment shown in the drawings and described in the description, which is given by way of example and not of limitation, but only in accordance with the scope of the appended claims.

1. A composite horseshoe having a central bight and a pair of oppositely facing arms, said horseshoe comprising:
a shoe having a bottom, a downwardly-facing wear surface, an upwardly-facing top interface surface, and a peripheral wall extending between said surfaces; and
a pad having a bottom downwardly-facing interface surface, a top upwardly facing bearing surface, and a peripheral wall extending between said surfaces;
said interface surfaces being coextensive and fixed to each other and substantially congruent with one another;
said shoe and said pad both being principally made of polymeric material, the polymeric material of the shoe being formulaically different from that of the pad, the material of each of them having the property of damping energy forces compressively applied to them, the said damping characteristic in each of the being inherently different than in the other one, such that the shock of a blow applied to the shoe is attenuated by the material of the shoe, and the shock delivered by the shoe to the pad is attenuated by the pad differently from the attenuation caused by the material of the shoe, so that the attenuated shock transmitted by the composite shoe is different from and less than that which would have been transmitted to the hoof had both the shoe and the pad been made of the same polymeric material, the principal material of the shoe being a polyamide, and the principal material of the pad being a polyvinyl.

2. A horseshoe according to claim 1 in which the material of the shoe is Nylon.

3. A horseshoe according to claim 2 in which the Nylon is Nylon 6, and the molecular weight of the Nylon is about 8.

4. A horseshoe according to claim 1 in which the material of the pad is polyvinyl chloride.

5. A horseshoe according to claim 4 in which the molecular weight of the polyvinyl chloride is about 17.

6. A horseshoe according to claim 2 in which the material of the pad is polyvinyl chloride.

7. A horseshoe according to claim 1 in which a cleat is included in the bight.

8. A horseshoe according to claim 1 in which the shoe further includes glass fibers mixed in the said material.

9. A horseshoe according to claim 6 in which the shoe further includes glass fibers mixed in the said material.
